(19) United States
(12) Patent Application Publication
(10) Pub. No.: US 2018/0228281 A1
(43) Pub. Date: Aug. 16, 2018

(54) Temperature Controlled-Shopping Cart System

(71) Applicant: Wal-Mart Stores, Inc., Bentonville, AR (US)

(72) Inventors: Matthew Dwain Biermann, Fayetteville, AR (US); Nicholaus Adam Jones, Fayetteville, AR (US); Steven Jackson Lewis, Bentonville, AR (US)

(21) Appl. No.: 15/879,629

(22) Filed: Jan. 25, 2018

Related U.S. Application Data
(60) Provisional application No. 62/458,104, filed on Feb. 13, 2017.

(51) Int. Cl. A47B 31/02; B62B 3/00; B65D 81/38; B62B 3/02; B62B 1/12

(52) U.S. Cl. CPC A47B 31/02; B62B 3/005; B65D 81/3813; B62B 3/02; F25D 2331/804; B62B 2204/02; B62B 2204/04; B62B 2204/06; B62B 1/12

(57) ABSTRACT

Described in detail herein are systems, methods for storing a physical object in a temperature-controlled storage unit disposed on a shopping cart. One or more physical objects can be stored and held within the interior volume via an interior volume of the storage unit operatively coupled to the shopping cart. The temperature of the interior volume of the storage unit can be controlled via a temperature controlling device operatively coupled to the storage unit. Sensors disposed within the interior volume of the storage unit can detect a the temperature of the interior volume. The sensors can encode the temperature into electrical signals and transmit the electrical signals from the plurality of sensors to a computing system. The computing system can determine whether the temperature is within a specified threshold and control the temperature-controlling device to adjust the first temperature to a third temperature.

### CROSS-REFERENCED APPLICATIONS

This application claims priority to U.S. Provisional Patent Application Ser. No. 62/458,104, entitled “TEMPERATURE CONTROLLED SHOPPING CART SYSTEM,” filed on Feb. 13, 2017, which is hereby incorporated by reference in its entirety.

### BACKGROUND

Controlling and maintaining temperatures of physical objects can maintain the physical object's quality and sustainability.

### BRIEF DESCRIPTION OF DRAWINGS

Illustrative embodiments are shown by way of example in the accompanying drawings and should not be considered as a limitation of the present disclosure:

FIG. 1A is a block diagram of an exemplary shopping cart with a temperature controlled storage unit according to embodiments of the present disclosure;

FIG. 1B is an interior view of the storage unit according to embodiments of the present disclosure;

FIG. 1C is a block diagram of an electrical circuit of the shopping cart according to embodiments of the present disclosure;

FIG. 1D illustrates an exemplary caster the cart according to the present disclosure;

FIG. 1E illustrates a perspective schematic view of an electromagnetic generator of a caster of the weight sensing system according to embodiments of the present disclosure;

FIG. 2 illustrates an exemplary temperature controlled storage system in accordance with embodiments of the present disclosure;

FIG. 3 illustrates an exemplary computing device in accordance with embodiments of the present disclosure; and

FIG. 4 is a flowchart illustrating a process of the temperature controlled storage system embodiments of the present disclosure.

### DETAILED DESCRIPTION

Described in detail herein are apparatuses, systems, and methods for storing a physical object in a temperature-controlled storage unit of a shopping cart. The shopping cart can include a frame, a basket supported by the frame, two front casters supporting the frame, and two rear casters supporting the frame. Each of the front two caster and the rear two caster can include a housing configured to be coupled to the frame and a wheel rotatable coupled to the housing. One or more physical objects can be stored and held within an interior volume of the temperature-controlled storage unit. The temperature setting of the interior volume of the storage unit can be controlled via a temperature controlling device operatively coupled to the storage unit. Sensors disposed within the interior volume of the storage unit can detect a first temperature of the interior volume and a second temperature of the one or more physical objects within the interior volume or a difference between the temperature of interior volume of the temperature controlled storage unit and the temperature of the one or more physical objects disposed within the interior volume. The sensors can encode the first and second temperature into electrical signals and transmit the electrical signals to a computing system. The computing system can decode the first and second temperatures from the electrical signals, and can determine whether the first temperature is within a specified threshold of the second temperature. The computing system can control the temperature-controlling device to adjust the first temperature to a different (third) temperature.

In exemplary embodiments, a temperature-controlled shopping cart system includes a shopping cart, a storage unit mechanically and electrically coupled to the shopping cart, a temperature controlling device, sensors disposed within an interior volume of the temperature-controlled storage unit, and a computing system. The interior volume of the temperature-controlled storage unit is configured to store and hold one or more physical objects within the interior volume. The temperature controlling device is operatively coupled to the storage unit, and is configured to control the temperature of the interior volume of the storage unit. The sensors are configured to detect a current temperature of the interior volume of the storage unit, a current temperature of the one or more physical objects disposed within the interior volume, encode the current temperatures into electrical signals, and transmit the electrical signals.

The computing system can include a database and can be communicatively coupled to the temperature controlling device and sensors. The computing system can be configured to receive the electrical signals associated with the detected current temperatures, decode the current temperatures from the electrical signals, and determine whether the current temperature of the interior volume is within a specified threshold of the current temperature of the one or more physical objects disposed in the interior volume. In response to determining a difference between the current temperature of the interior volume and the current temperature of the one or more physical objects is greater than a specified threshold, the computing system can control the temperature-controlling device to adjust the current temperature of the interior volume to another temperature to reduce the difference between the temperature within the interior volume and the temperature of the one or more physical objects disposed in the interior volume. In some embodiments, the computing system can be configured to query the database using the temperature of the one or more physical objects when the one or more physical objects are first disposed in the interior volume to retrieve a set of attributes associated with the one or more physical objects and to dynamically determine the specified threshold based on the set of attributes associated with the one or more physical objects.

The system further includes an electric circuit operatively coupled to the computing system. The electric circuit can be distributed throughout the shopping cart. The electric circuit includes a battery, a reader, an electromagnetic generator, a controller, The battery can be configured to power the electric circuit. The reader can be mounted on the frame, handle, or the basket of the shopping cart, and can be configured to read machine-readable elements associated with physical objects being placed on the shopping cart and/or in the interior volume of the temperature-controlled storage unit. The electromagnetic generator is operatively coupled to the wheel of at least one of the two front casters or at least one of the two rear casters. The electromagnetic generator can be configured to output an electrical current in response to rotation of the wheel. The controller can be operatively coupled to the battery, the reader, and the electromagnetic generator. The controller can be configured to control the reader to read the machine-readable elements and transition from a first mode of operation to a second mode of operation in response to receiving the electrical current from the electromagnetic generator. The temperature-controlled storage unit can be selectively mounted to the frame or basket of the shopping cart to couple and decouple the temperature-controlled storage unit with the electrical circuit of the shopping cart. When the temperature-controlled storage unit is coupled to the frame or basket, the electrical circuit is operatively coupled to the sensors and the temperature controlling device of the temperature-controlled storage unit, and the electrical circuit can power to the sensors and the temperature controlling device. The computing system can receive machine-readable elements associated with the one or more physical objects read by the reader, and can query the database to retrieve a set of attributes associated with the one or more physical objects. The computing system can determine specified threshold based on the set of attributes associated with the one or more physical objects.

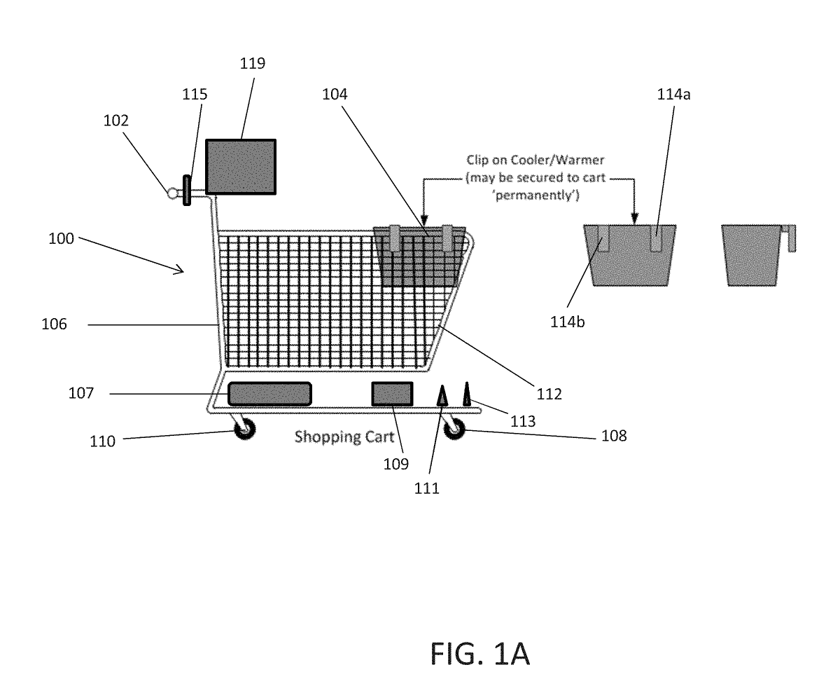

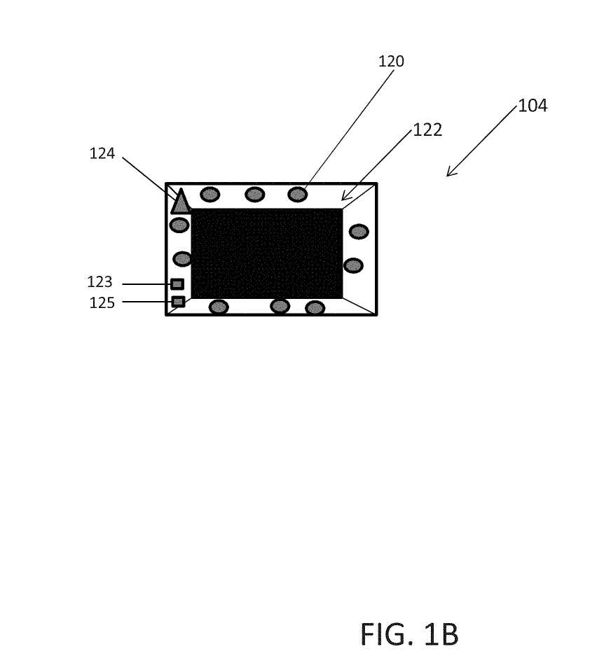

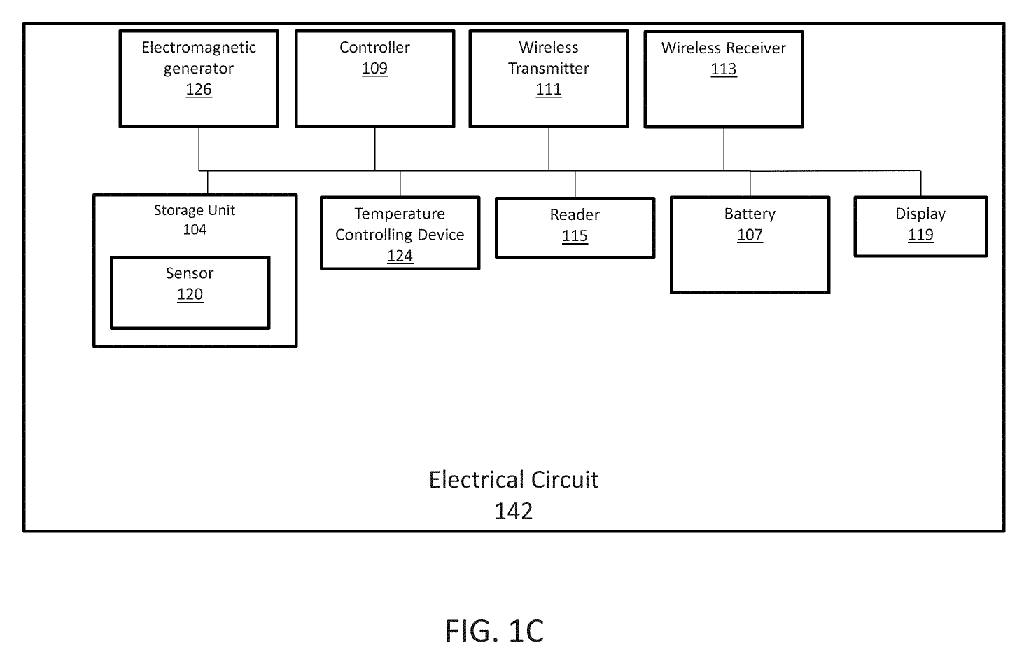

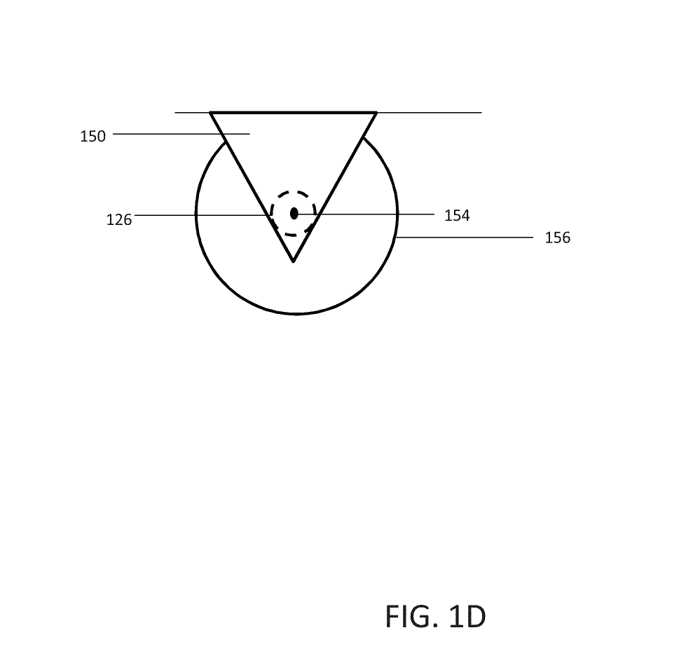

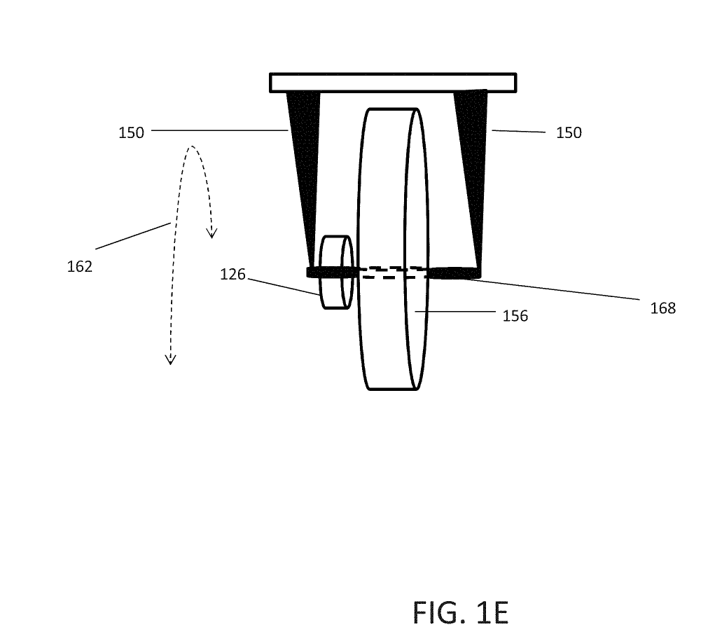

FIG. 1A is a block diagram of an exemplary shopping cart 100 with a temperature controlled storage unit 104 and an electric circuit according to the present disclosure. The shopping cart 100 can include a handle 102, frame 106, a basket 112 supported by the frame 106, two front casters 100 supporting the frame 106, and two rear casters 108 supporting the frame 106. Each of the front two casters 110 and the rear two casters 108 can include a housing coupled to the frame 106 and a wheels can be rotatable coupled to the housing. The basket 106 can be configured to receive physical objects. The electrical circuit can include a battery 107, a controller 109, a wireless transmitter 111, a wireless receiver 113, a reader 115 and a display 119.

The temperature controlled storage unit 104 can include two handles or clips 114a-b as well as a front wall, a back wall, two side walls, a top wall, and a base. The two handles 114a-b can be disposed on the back wall. The front wall, back wall, the two side walls, the top wall, and the base can define an interior volume of the temperature-controlled storage unit 104. The interior volume of the temperature-controlled storage unit 104 can be configured to store, house and support physical objects. The temperature-controlled storage unit 104 can be secured to the basket 104 and/or other portions of the shopping cart 100 (e.g., the handle 102 and/or frame 106) using the handles 114a-b. In some embodiments, the temperature-controlled storage unit 104 can be made of insulating material.

FIG. 1B is an interior view of an embodiment of the temperature-controlled storage unit 104 according to the present disclosure. The storage unit 104 can include an interior volume 122. Multiple sensors 120 can be disposed within the interior volume and/or can be integrated with the front wall, the back wall, the two side walls, the top wall, and the base. A temperature of the interior volume 122 can be controlled by at least one temperature controlling device 124. The temperature controlling device 124 can be disposed internal or external to the temperature-controlled storage unit 104. The sensors 120 can be temperature sensors configured to detect an interior temperature of the interior volume 122 of the temperature controlled storage unit 104 and/or the temperature of physical objects disposed within the interior volume 122. In some embodiments, the sensors 120 can be mechanical temperature sensors such as thermometers, or bi-metallic strips. Alternatively, the sensors 120 can be electrical temperature sensors such as thermistors, thermocouples, resistance thermometers, or silicon bandgap temperature sensor. The temperature controlling device 124 can be configured to maintain the interior temperature at and/or to adjust the interior temperature towards a specified temperature. The temperature controlling device 124 can be a thermoelectric device which creates a voltage when there is a different temperature on each side. An applied temperature gradient causes charge carriers in the interior volume of the storage unit 104 to diffuse from a hot side to a cold side or vice versa. The thermoelectric device can generate the thermoelectric effect, such as a Seebeck effect, a Peltier effect, or Thompson effect. The temperature controlling device 124 can be one or more of, on-off controllers, autotune PID controllers, multiloop controllers, safety limit controllers, and temperature switches. The sensors can detect the interior temperature of the interior volume 122 and encode the interior temperature into electrical signals. The electrical signals can be output by the sensors and received by the controller, which can control the wireless transmitter to transmit the electrical signals to a computing system. In some embodiments, the temperature controlling device 124 can be an active coolant system. The temperature controlling device 124 can receive instructions to adjust the interior temperature of the interior volume 122 from the computing system.

FIG. 1C is a block diagram of an electrical circuit 142 of an embodiment of the shopping cart 100 according to the present disclosure. The electric circuit 142 can be distributed throughout the shopping cart, and can include a battery 107, a controller 109, a reader 115, a display 119 a temperature controlling device 124 disposed within or with respect to the storage unit 104, sensors 120 disposed within the storage unit 104, wireless transmitter 111, wireless receiver 113, and electromagnetic generators 126 disposed in the front casters 108 and the rear casters 110.

The battery 107 can be configured to power the electric circuit 142. The sensors 140 can be configured to detect the interior temperature within the interior volume of the storage unit 104. The sensors 120 can output electrical signals in response detecting a change in the interior temperature that is greater than a threshold amount of change. The controller 109 can be configured to receive the output of the sensors 120 and the reader 107, and to control the temperature controlling device based on the output of the sensors 120 and/or the reader 107. The reader 107 can be an optical scanner configured to scan machine-readable elements such as barcodes or QR codes or RFID reader configured to read RFID tags. The display 119 can be configured to display information associated with the barcodes and/or QR codes.

As an example, the reader 107 can be configured to scan machine-readable elements affixed to and associated with a physical object, which can be disposed in the interior volume of the temperature-controlled storage unit. In response to detecting an increase or decrease of the interior temperature in the interior volume of the storage unit 104, e.g., resulting from the physical object being placed in the storage unit 104, the controller 109 can receive electrical signals output by the sensors that correspond to the change in the interior temperature. The controller 109 can determine an aggregate or average change of the interior temperature in response to the physical objects being placed in the storage unit 104. The controller 109 can also receive electrical signals corresponding to a change of the interior temperature each time a physical object is placed in the storage unit. A wireless transmitter 111 can be coupled with the controller 109 and can be controlled by the controller 109 to transmit data to a computing system. The wireless receiver 113 of the electric circuit can be configured to receive data and to output the received data to the controller 109.

The electromagnetic generators 126 can be configured to power the electric circuit 142 and/or recharge the battery. For example, as the wheels of the shopping cart are manually driven by a user, an electric current can be induced in the electromagnetic generator 126, and the electric current can be used to power the electric circuit or recharge the battery. The electric circuit 142 can provide power to sensors 120 and the temperature controlling device 124 in response to the storage unit 104 being secured to the shopping cart.

The controller can receive the electric current from the electromagnetic generator 126 and can control a mode of operation of the electric circuit of the cart in response to the electrical current. In one example, the controller can power on the sensors 120, temperature controlling device 124, the reader 115 and the display 119, in response to the rotation of the wheels and receiving an electrical current and can power down the display and the reader when the cart is stationary (e.g., when no electric current is being generated by the electromagnetic generator 126). A threshold electric current can be specified such that the controller can power on the display and the reader in response to receiving an electrical current that exceeds the threshold. In some embodiments, controller can be configured to wait to power on the display and reader for time period after the threshold is (continuously or otherwise) exceeded and/or can wait to power down the display and reader for a time period after the threshold is no longer exceeded.

In another example, the controller 109 can power down display 119 and reader 115 when the wheels are rotating and cart is in motion. The controller can store power being produced by the electromagnetic generator 126 upon rotation of the wheels (e.g., by charging the battery or a capacitor). The controller can use the stored power to power on the display and the reader when the wheels are not rotating and the cart is stationary.

FIGS. 1D-1E illustrate an exemplary electromagnetic generator 126 of a caster according to the present disclosure. Referring to FIGS. 1D and 1E, the electromagnetic generator 126 can be disposed with respect to the housing 150 and the wheel 156. The electromagnetic generator 126 can be secured to the housing 150 of the caster, and can output an electrical current in response to the rotation of the wheel 156. A shaft 168 can be coupled to the wheel 156 and the electromagnetic generator 126 and can rotate with the wheel 156. The shaft can include, for example, a magnet disposed at a terminal end, which can be surrounded by a conductive coil such that rotation of the shaft causes the magnet to rotate with respect to the conductive coil and results in an electrical current being induced in the conductive coil.

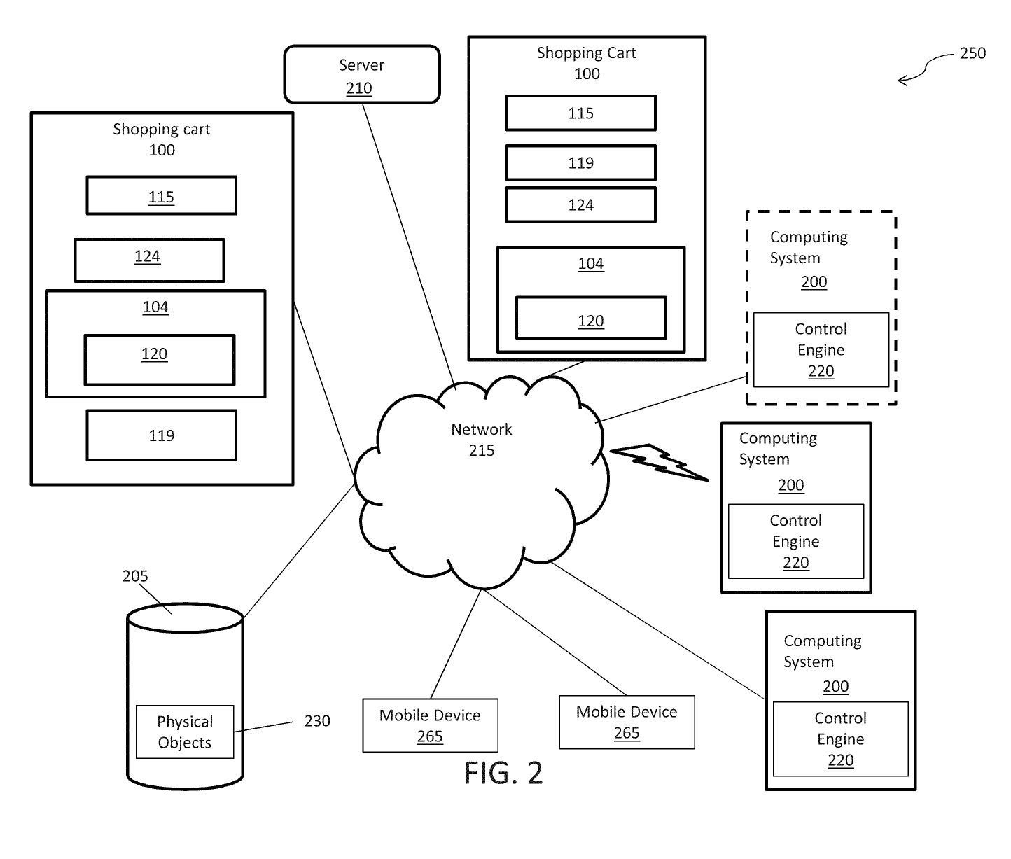

FIG. 2 illustrates an exemplary temperature controlled storage system 250 in accordance with exemplary embodiments of the present disclosure. The temperature controlled storage system 250 can include one or more databases 205, one or more servers 210, one or more computing systems 200, shopping carts 100 with electric circuits and temperature-controlled storage units selectively or permanently affixed thereto, and mobile devices 265. The shopping carts 100 can include sensors 120 disposed within storage units 104, temperature controlling devices 124, readers 115 and displays 119. In exemplary embodiments, the computing system 200 is in communication with the databases 205, a server 210, and shopping carts 100 and the mobile devices 265, via a communications network 215. The temperature controlling device 124 can control and maintain the interior temperature of the interior volume of the storage unit 104. The sensors 120 can detect the interior temperature of the interior volume of the storage unit 104 and object temperatures of physical objects deposited in the interior volume of the storage unit. The computing system can execute one or more instances of a control engine 220. The control engine 220 can be an executable program on residing on the computing system 200. The control engine 220 can implement the temperature controlled storage system 250.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 210 and the databases 205 can be connected to the communications network 215 via a wired connection. Alternatively, the server 210 and the databases 205 can be connected to the network 215 via a wireless connection. The server 210 includes one or more computers or processors configured to communicate with the computing system 200 and the databases 205, via the network 215. The server 210 hosts one or more applications configured to interact with one or more components computing system 200 and/or facilitates access to the content of the databases 205. The databases 205 can store information/data, as described herein. For example, the databases 205 can include a physical objects database 230. The physical objects database 230 can include information associated with physical objects disposed in facilities (e.g., such as unique identifiers associated with the physical objects, names of the physical object, types of the physical objects, stored weights of the physical objects, and stored images of the physical objects, ideal storage temperatures). The databases 205 and server 210 can be located at one or more geographically distributed locations from each other or from the computing system 200. Alternatively, the databases 205 can be included within server 210.

In exemplary embodiments, a user can deposit a physical object in the storage unit 104 disposed on the shopping cart 100. The physical object can have an initial temperature when place in the storage unit 104. The sensors 120 can detect the interior temperature of the interior volume of the storage unit 104 and the initial temperature of the physical object. The sensors 120 can detect a difference between the interior temperature of the interior volume and the initial temperature of the physical object. The sensors 120 can encode the temperatures or the difference between the temperatures into electrical signals. The electric circuit of the shopping cart can transmit the electrical signals to the computing system 200. The computing system 200 can execute the control engine 220 in response to receiving the electrical signals. The control engine 220 can decode the temperatures or difference between the temperatures from the electrical signals, and can determine the interior temperature of the interior volume of the storage unit 104 is greater than or less than the initial temperature of the physical object by more than a specified threshold temperature difference. The control engine 220 can determine a new temperature at which the interior volume should be set to store the physical object in the storage unit based on the initial temperature of the physical object or based on a difference between the interior temperature of the interior volume and the initial temperature of the physical object. The control engine 220 can control the temperature controlling device 124 to adjust the temperature of the interior volume of the storage unit 104 towards the new temperature.

In some embodiments, a user can scan a machine-readable element disposed on the physical object using the reader 115, prior to depositing the physical object in the storage unit 104. The reader 115 can decode an encoded identifier associated with the physical object from the machine-readable element and can transmit, via the wireless transmitter of the electrical circuit, the identifier to the computing system 200 to be used by the computing system 200 in conjunction with the electrical signals received from the wireless transmitter of the electric circuit corresponding to the temperatures detected by the sensors. The computing system 200 can execute the control engine 220 in response to receiving the identifier associated with the physical object and the electrical signals. The control engine 220 can decode the temperatures or the difference between the temperatures from the electrical signals, and can determine the interior temperature of the interior volume of the storage unit 104 is greater than or less than the initial temperature of the physical object by more than a specified threshold amount. The control engine 220 can query the physical objects database 230 using the identifier, to retrieve information associated with the physical object deposited in the storage unit 104. The information can include, name, type of object, size, weight, dimensions and suggested storage temperatures. The control engine 220 can determine a new temperature at which to store the physical object based on the retrieved set of information. The control engine 220 can control the temperature controlling device 124 to adjust the interior temperature of the interior volume of the storage unit 104 towards the new temperature.

In some embodiments, the control engine 220 can determine the physical object has been stored at the detected temperature for more than a specified threshold amount of time. The control engine 220 can transmit an alert to a mobile device 265. The storage unit can also include a light source and/or speakers. The control engine 220 can control the operation of a light source to generate light effects or the operation of speakers to generate audible sounds, in response to determining the physical object has been stored at the detected temperature for more than a specified threshold amount of time. The control engine 220 can determine storing the physical object at the detected temperature for more than a specified threshold amount of time can damage the physical object or cause the physical object to decompose. The control engine 220 can calculate a new temperature to reduce the damage or decomposition to the physical object caused by the detected temperature. The control engine 220 can control the temperature controlling device 124 to adjust the interior temperature of the interior volume of the storage unit 104 toward the new temperature.

In some embodiments a user can scan a first and second machine-readable element disposed on a first and second physical object using the reader 115, prior to depositing the physical object in the storage unit 104. The reader 115 can decode an encoded first and second identifier associated with the first and second physical objects from the first and second machine-readable elements and can transmit, via the wireless transmitter of the electrical circuit, the first and second identifiers to the computing system 200 to be used by the computing system 200 in conjunction with the electrical signals received from the wireless transmitter of the electric circuit corresponding to the temperatures detected by the sensors. The computing system 200 can execute the control engine 220 in response to receiving the first and second identifiers associated with the first and second physical objects and the electrical signals. The control engine 220 can decode the temperatures or the difference between the temperatures from the electrical signals, and can determine the interior temperature of the interior volume of the storage unit 104 is greater than or less than the initial temperature of the first and second physical objects by more than a specified threshold amount. The control engine 220 can query the physical objects database 230 using the first and second identifiers, to retrieve information associated with the first and second physical objects deposited in the storage unit 104. The information can include, name, type of object, size, weight, dimensions and suggested storage temperatures. The control engine 220 can determine a new temperature at which to store the first and second physical objects based on the retrieved set of information. The control engine 220 can control the temperature controlling device 124 to adjust the interior temperature of the interior volume of the storage unit 104 towards the new temperature.

In some embodiments, the control engine 220 can transmit the adjusted temperature to a mobile device 265 of the user. The adjusted temperature can be displayed on the mobile device 265. The control engine 220 can receive instructions from the user of the mobile device to adjust the temperature based on received user input on the mobile device.

As a non-limiting example, the temperature controlled storage system 250 can be implemented in a retail store. In exemplary embodiments, a customer a user can deposit a product intended for purchase in the storage unit 104 disposed on the shopping cart 100. The product can have an initial temperature when place in the storage unit 104. The sensors 120 can detect the interior temperature of the interior volume of the storage unit 104 and the initial temperature of the product. The sensors 120 can detect a difference between the interior temperature of the interior volume and the initial temperature of the physical object. The sensors 120 can encode the temperatures or the difference between the temperatures into electrical signals. The electric circuit of the shopping cart can transmit the electrical signals to the computing system 200. The computing system 200 can execute the control engine 220 in response to receiving the electrical signals. The control engine 220 can decode the temperatures or difference between the temperatures from the electrical signals, and can determine the interior temperature of the interior volume of the storage unit 104 is greater than or less than the initial temperature of the product by more than a specified threshold temperature difference. The control engine 220 can determine a new temperature at which the interior volume should be set to store the product in the storage unit based on the initial temperature of the product or based on a difference between the interior temperature of the interior volume and the initial temperature of the product. The control engine 220 can control the temperature controlling device 124 to adjust the temperature of the interior volume of the storage unit 104 towards the new temperature.

In some embodiments, a customer can scan a machine-readable element disposed on the product using the reader 115, prior to depositing the product in the storage unit 104. The reader 115 can decode an encoded identifier associated with the product from the machine-readable element and can transmit, via the wireless transmitter of the electrical circuit, the identifier to the computing system 200 to be used by the computing system 200 in conjunction with the electrical signals received from the wireless transmitter of the electric circuit corresponding to the temperatures detected by the sensors. The computing system 200 can execute the control engine 220 in response to receiving the identifier associated with the product and the electrical signals. The control engine 220 can decode the temperatures or the difference between the temperatures from the electrical signals, and can determine the interior temperature of the interior volume of the storage unit 104 is greater than or less than the initial temperature of the product by more than a specified threshold amount. The control engine 220 can query the physical objects database 230 using the identifier, to retrieve information associated with the product deposited in the storage unit 104. The information can include, name, type of object, size, weight, dimensions and suggested storage temperatures. The control engine 220 can determine a new temperature at which to store the product based on the retrieved set of information. The control engine 220 can control the temperature controlling device 124 to adjust the interior temperature of the interior volume of the storage unit 104 towards the new temperature.

In some embodiments, a customer can scan machine-readable elements for a first product and second product from the retail store and deposit the first and second product in the storage unit 104. For example, the first and second products can be ice cream and yogurt. The reader 115 can decode an encoded first and second identifier associated with the ice cream and yogurt from the first and second machine-readable elements and can transmit, via the wireless transmitter of the electrical circuit, the first and second identifiers to the computing system 200 to be used by the computing system 200 in conjunction with the electrical signals received from the wireless transmitter of the electric circuit corresponding to the temperatures detected by the sensors. The computing system 200 can execute the control engine 220 in response to receiving the first and second identifiers associated with the ice cream and yogurt and the electrical signals. The control engine 220 can decode the temperatures or the difference between the temperatures from the electrical signals, and can determine the interior temperature of the interior volume of the storage unit 104 is greater than or less than the initial temperature of the ice cream and yogurt by more than a specified threshold amount. The control engine 220 can query the physical objects database 230 using the first and second identifiers, to retrieve information associated with the ice cream and yogurt deposited in the storage unit 104. The information can include, name, type of object, size, weight, dimensions and suggested storage temperatures. The control engine 220 can determine a new temperature at which to store the ice cream and yogurt based on the retrieved set of information. The control engine 220 can control the temperature controlling device 124 to adjust the interior temperature of the interior volume of the storage unit 104 towards the new temperature.

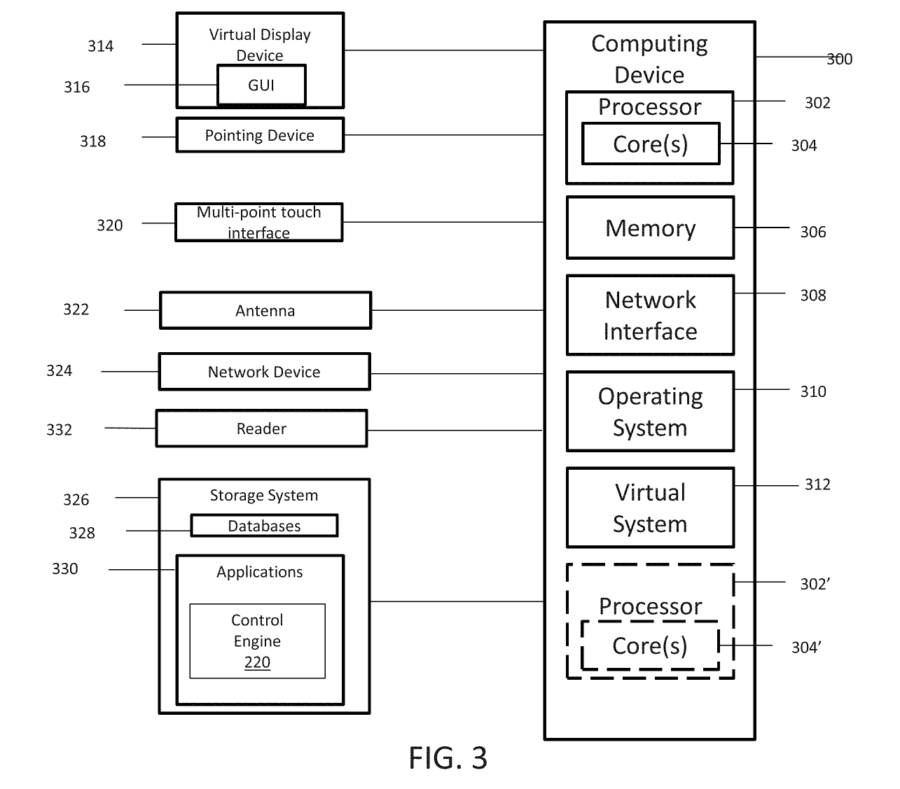

FIG. 3 is a block diagram of an example computing device for implementing exemplary embodiments of the present disclosure. Embodiments of the computing device 300 can implement embodiments of the temperature controlled storage system. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 such as the control engine 220) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 406 may include other types of memory as well, or combinations thereof. The computing device 300 can receive data from input/output devices such as, a reader 332.

A user may interact with the computing device 300 through a visual display device 314, such as a computer monitor, which may display one or more graphical user interfaces 316, multi touch interface 320 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information regarding the physical objects. The databases 328 may be updated manually or automatically at any suitable time to add, delete, and/or update one or more data items in the databases. The databases 328 can include information associated with physical objects disposed in the facility.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

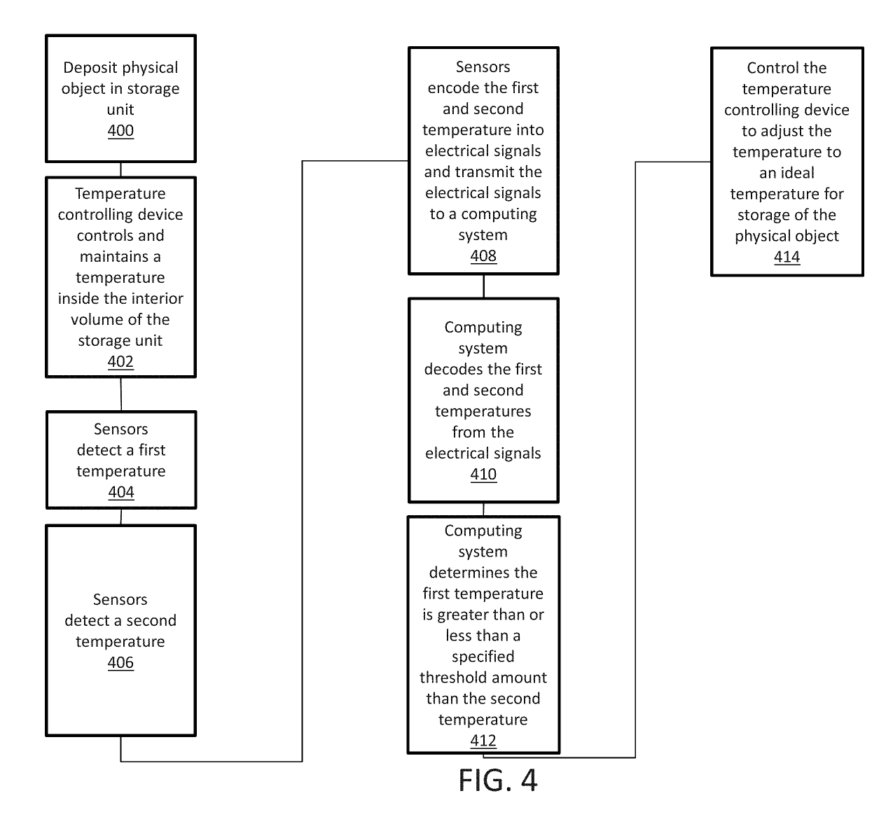

FIG. 4 is a flowchart illustrating a process of implementing a temperature controlled storage system according to exemplary embodiments of the present disclosure. In operation 400, a physical object is deposited in a storage unit (e.g. storage unit 104 as shown in FIG. 1A-2) mechanically and electrically coupled to a shopping cart (e.g. shopping cart 100 as shown in FIG. 1A and 2) having an electric circuit (e.g. electrical circuit 142 as shown in FIG. 1C). In operation 402, a temperature controlling device (e.g. temperature controlling device 124 as shown in FIGS. 1B, 1C and 2) can control and maintain an interior temperature of the interior volume of the storage unit. In operation 404, sensors (e.g. sensors 120 as shown in FIGS. 1B, 1C and 2) can detect the interior temperature of the interior volume of the storage unit. In operation 406, the sensors can detect an object temperature of the physical object deposited in the interior volume. In operation 408, the sensors can encode the interior and object temperatures into electrical signals or can encode the difference between the interior and object temperatures into electrical signals. The sensors can output the electrical signals to the electric circuit of the shopping cart, which can transmit the electrical signals to a computing system (e.g. computing system 200 as shown in FIG. 2). In operation 410, the computing system can decode the interior and object temperatures or the difference between the interior and object temperatures from the electrical signals. In operation 412, the computing system can determine that the difference interior between the interior and object temperatures is greater than a specified threshold amount. In operation 414, the computing system can control the temperature controlling device to adjust the interior temperature towards a new temperature that is a suitable temperature at which the physical object can be stored. The new temperature can be based on the difference between the interior and object temperatures and/or an identity of the physical object.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An temperature-controlled -shopping cart system, the system comprising:
a shopping cart including a frame, a basket supported by the frame, two front casters supporting the frame, and two rear casters supporting the frame, each of the front two caster and the rear two caster including a housing configured to be coupled to the frame and a wheel rotatable coupled to the housing;
a storage unit mechanically and electrically coupled to the shopping cart, the storage unit including an interior volume and being configured to:
store and hold one or more physical objects within the interior volume;
a temperature controlling device operatively coupled to the storage unit, configured to control the temperature of the interior volume of the storage unit;
a plurality of sensors disposed within the interior volume of the storage unit, the plurality of sensors configured to:
detect a first temperature of the interior volume of the storage unit,
detect a second temperature of the one or more physical objects within the interior volume;
encode the first and second temperature into electrical signals;
transmit the electrical signals;
and
a computing system including a database and operatively coupled to the temperature controlling device and plurality of sensors, the computing system configured to:
receive the electrical signals;
decode the first and second temperatures from the electrical signals;
determine whether the first temperature is within a specified threshold of the second temperature;
control the temperature-controlling device to adjust the first temperature to a third temperature, in response to determining the first temperature is greater than or less than a predetermined threshold of the second temperature.

2. The system of claim 1, wherein the computing system is further configured to:
query the database using the second temperature to retrieve a set of attributes associated with the one or more physical objects; and
determine the specified threshold based on the set of attributes associated with the one or more physical objects.

3. The system of claim 1, wherein the temperature-controlling device is an active coolant.

4. The system of claim 1, wherein the storage unit are made of one or more insulated materials.

5. The system of claim 1, wherein the computing system is further configured to transmit an alert including the third temperature.

6. The system of claim 1, further comprising a mobile device communicatively coupled to the computing system, the mobile device configured to:
receive the alert; and
display the third temperature.

7. The system of claim 1, further comprising an electric circuit operatively coupled to the computing system, the electric circuit being distributed throughout the shopping cart, the electric circuit including:
a battery configured to power the electric circuit;
a reader mounted on the frame or the basket, the reader being configured to read machine-readable elements associated with physical objects being placed in the shopping cart;
an electromagnetic generator operatively coupled to the wheel of at least one of the two front casters or at least one of the two rear casters, the electromagnetic generator is configured to output an electrical current in response to rotation of the wheel; and
a controller operatively coupled to the battery, the reader, and the electromagnetic generator, the controller being configured to control the reader to read the machine-readable elements and transition from a first mode of operation to a second mode of operation in response to receiving the electrical current from the electromagnetic generator.

8. The system of claim 7, wherein the storage unit is selectively mounted to the frame of the shopping cart and coupled to the electrical circuit.

9. The system of claim 7, wherein the electrical circuit is operatively coupled to the sensors and the temperature controlling device and the electrical circuit is configured to provide power to the sensors and the temperature controlling device.

10. The system of claim 7, wherein the reader is configured to scan one or more machine readable element associated with the one or more physical objects in the storage unit and transmit the scanned machine-readable elements associated with the one or more physical objects.

11. The system in claim 9, wherein the computing system is further configured to:
receive the one or more machine-readable elements associated with the one or more physical objects;
query the database to retrieve a set of attributes associated with the one or more physical objects; and
determine the predetermined threshold based on the set of attributes associated with the one or more physical objects.

12. A method for storing a physical object in a temperature-controlled -shopping cart including a frame, a basket supported by the frame, two front casters supporting the frame, and two rear casters supporting the frame, each of the front two caster and the rear two caster including a housing configured to be coupled to the frame and a wheel rotatable coupled to the housing, the method comprising:
storing and holding one or more physical objects within the interior volume via an interior volume of a storage unit operatively coupled to the shopping cart;
controlling a temperature of the interior volume of the storage unit via a temperature controlling device operatively coupled to the storage unit;
detecting a first temperature of the interior volume of the storage unit via a plurality of sensors disposed within the interior volume of the storage unit;
detecting a second temperature of the one or more physical objects within the interior volume via the plurality of sensors;
encoding the first and second temperature into electrical signals via the plurality of sensors;
transmitting the electrical signals from the plurality of sensors to a computing system;
decoding the first and second temperatures from the electrical signals via the computing system;
determining whether the first temperature is within a specified threshold of the second temperature via the computing system; and
controlling the temperature-controlling device to adjust the first temperature to a third temperature via the computing system in response to determining the first temperature is greater than or less than a predetermined threshold of the second temperature.

13. The method of claim 12, further comprising:
querying, via the computing system, the database using the second temperature to retrieve a set of attributes associated with the one or more physical objects; and
determining, via the computing system, the specified threshold based on the set of attributes associated with the one or more physical objects.

14. The method of claim 12, wherein the temperature-controlling device is an active coolant.

15. The method of claim 12, wherein the storage unit are made of one or more insulated materials.

16. The method of claim 12, further comprising transmitting, via the computing system, an alert including the third temperature.

17. The method of claim 16, further comprising:
receiving, a mobile device communicatively coupled to the computing system, the alert; and
displaying, via the mobile device, the third temperature.

18. The method of claim 12, wherein an electric circuit including a battery, a reader mounted on the frame or the basket, an electromagnetic generator operatively coupled and to the wheel of at least one of the two front casters or at least one of the two rear casters, and a controller operatively coupled to the battery, the reader, and the electromagnetic generator, is operatively coupled to the computing system, the electric circuit is distributed throughout the shopping cart.

19. The method of claim 18, further comprising:
powering the electric circuit via the battery;
reading machine-readable elements associated with physical objects being placed on the first cart via the reader;
outputting, via the electromagnetic generator, an electrical current in response to rotation of the wheel; and
controlling, via the controller, the reader to read the machine-readable elements and transition from a first mode of operation to a second mode of operation in response to receiving the electrical current from the electromagnetic generator.

20. The method of claim 19, wherein the storage unit is selectively mounted to the frame of the shopping cart and coupled to the electrical circuit.

21. The method of claim 19, further comprising, providing, via the electrical circuit operatively coupled to the sensors and the temperature controlling device, power to the sensors and the temperature controlling device.

22. The method of claim 19, further comprising:
scanning, via the reader, scan one or more machine readable element associated with the one or more physical objects in the storage unit; and
transmitting, via the reader, the scanned machine-readable elements associated with the one or more physical objects.

23. The method in claim 22, further comprising:
receiving, the computing system, the one or more machine-readable elements associated with the one or more physical objects;
querying, the computing system, the database to retrieve a set of attributes associated with the one or more physical objects; and
determining, the computing system, the predetermined threshold based on the set of attributes associated with the one or more physical objects.
